(19) United States
(12) Patent Application Publication
(10) Pub. No.: US 2026/0340996 A1
(43) Pub. Date: Oct. 29, 2026

(54) VEHICLE PERCEPTION SENSOR CALIBRATION

(71) Applicant: GM Global Technology Operations LLC, Detroit, MI (US)

(72) Inventors: Yousef Adnan Omar, Troy, MI (US); Akhil Kurup, Sterling Heights, MI (US); Mohsen Khalili, Palo Alto, CA (US); Hao Yu, Troy, MI (US)

(21) Appl. No.: 19/188,508

(22) Filed: Apr. 24, 2025

(51) Int. Cl. G06V 10/774; G01S 17/86; G01S 17/931; G06V 10/82; G06V 20/56

(52) U.S. Cl. CPC G06V 10/774; G01S 17/86; G01S 17/931; G06V 10/82; G06V 20/56

(57) ABSTRACT

According to several aspects, a method for calibrating a coordinate transformation matrix (CTM) for two or more sensors may include training a machine learning model to align sensor data. The method further may include recording a plurality of sensor measurements using two or more sensors. The method further may include generating a plurality of bird's-eye-view (BEV) sensor measurements using the CTM of each of the two or more sensors. The method further may include updating the CTM of each of the two or more sensors using the machine learning model. The method further may include repeating the recording the plurality of sensor measurements, generating the plurality of BEV sensor measurements, and updating the CTM of each of the two or more sensors steps until a CTM convergence threshold is reached for the CTM of each of the two or more sensors.

### INTRODUCTION

The present disclosure relates to sensing systems and methods for vehicles, and more particularly, to systems and methods for sensor calibration for vehicles.

To operate vehicle sensing and perception systems, one or more sensors may be used. Sensors may include, for example, cameras, radar units, LIDAR systems, ultrasonic sensors, and/or the like. These sensors may be positioned at various locations on or within a vehicle and are configured to collect environmental and/or vehicle state information to support functions such as object detection, localization, navigation, and path planning. In some examples, sensors are installed as part of an advanced driver assistance system (ADAS) or an automated driving system (ADS). Accurate calibration of the sensors is necessary to ensure proper interpretation of sensor data when combining data from multiple sensing modalities or when associating sensor output with vehicle coordinate frames. Calibration may be performed during initial manufacturing or periodically during operation to maintain performance over time. Calibration systems and methods may use reference markers, fiducial patterns, or reflective surfaces to determine sensor pose relative to the vehicle structure or to a global coordinate frame.

While current sensing systems and methods achieve their intended purpose, there is a need for a new and improved system and method for calibrating a coordinate transformation matrix (CTM) for two or more sensors.

### SUMMARY

According to several aspects, a method for calibrating a coordinate transformation matrix (CTM) for two or more sensors is provided. The method may include training a machine learning model to align sensor data. The method further may include recording a plurality of sensor measurements using two or more sensors. The method further may include generating a plurality of bird's-eye-view (BEV) sensor measurements by transforming each of the plurality of sensor measurements into a BEV coordinate space using the CTM of each of the two or more sensors. The BEV coordinate space is a two-dimensional coordinate space relative to the two or more sensors. The method further may include updating the CTM of each of the two or more sensors using the machine learning model based at least in part on the plurality of BEV sensor measurements. The method further may include repeating the recording the plurality of sensor measurements, generating the plurality of BEV sensor measurements, and updating the CTM of each of the two or more sensors steps until a CTM convergence threshold is reached for the CTM of each of the two or more sensors.

In another aspect of the present disclosure, training the machine learning model further may include recording a plurality of training sensor measurements using the two or more sensors. Training the machine learning model further may include generating a plurality of training BEV sensor measurements based at least in part on the plurality of training sensor measurements. Training the machine learning model further may include training the machine learning model based at least in part on the plurality of training BEV sensor measurements and a ground-truth CTM for each of the two or more sensors.

In another aspect of the present disclosure, generating the plurality of training BEV sensor measurements further may include generating the plurality of training BEV sensor measurements by transforming the each of the plurality of training sensor measurements into the BEV coordinate space using the ground-truth CTM of each of the two or more sensors injected with a randomized error.

In another aspect of the present disclosure, recording the plurality of sensor measurements further may include recording the plurality of sensor measurements using the two or more sensors. One or more of the two or more sensors is a camera.

In another aspect of the present disclosure, recording the plurality of sensor measurements further may include recording the plurality of sensor measurements using the two or more sensors. One or more of the two or more sensors is a light detection and ranging (LIDAR) sensor.

In another aspect of the present disclosure, generating the plurality of BEV sensor measurements further may include generating the plurality of BEV sensor measurements by transforming each of the plurality of sensor measurements into the BEV coordinate space. Each of the plurality of BEV sensor measurements is a BEV representation of one of the plurality of sensor measurements from one of the two or more sensors.

In another aspect of the present disclosure, generating the plurality of BEV sensor measurements further may include generating the plurality of BEV sensor measurements. The plurality of BEV sensor measurements include information about a field of view of each of the plurality of sensor measurements. The plurality of BEV sensor measurements include information about overlap in the field of view of each of the plurality of sensor measurements.

In another aspect of the present disclosure, updating the CTM of each of the two or more sensors further may include providing the plurality of BEV sensor measurements to the machine learning model. The plurality of BEV sensor measurements are provided to the machine learning model as a multi-channel input which includes information about a spatial relationship between each of the plurality of BEV sensor measurements. Updating the CTM of each of the two or more sensors further may include generating an adjustment matrix for the CTM of each of the two or more sensors using a vision-based neural network of the machine learning model based at least in part on the multi-channel input. Updating the CTM of each of the two or more sensors further may include updating the CTM of each of the two or more sensors using the adjustment matrix for the CTM of each of the two or more sensors.

In another aspect of the present disclosure, generating the adjustment matrix for the CTM of each of the two or more sensors further may include generating the adjustment matrix for the CTM of each of the two or more sensors. A magnitude of each of one or more values of the adjustment matrix is less than or equal to a predetermined maximum adjustment threshold.

In another aspect of the present disclosure, repeating the recording the plurality of sensor measurements, generating the plurality of BEV sensor measurements, and updating the CTM of each of the two or more sensors steps further may include repeating the recording the plurality of sensor measurements, generating the plurality of BEV sensor measurements, and updating the CTM of each of the two or more sensors steps, where the CTM convergence threshold is reached when a magnitude of each of one or more values of the adjustment matrix is less than or equal to the CTM convergence threshold.

According to several aspects, a system for calibrating a coordinate transformation matrix (CTM) for a vehicle is provided. The system may include two or more sensors and a controller in electrical communication with the two or more sensors. The controller is programmed to record a plurality of sensor measurements using two or more sensors. The controller is further programmed to generate a plurality of bird's-eye-view (BEV) sensor measurements by transforming each of the plurality of sensor measurements into a BEV coordinate space using the CTM of each of the two or more sensors. The BEV coordinate space is a two-dimensional coordinate space relative to the two or more sensors. The controller is further programmed to update the CTM of each of the two or more sensors using a machine learning model based at least in part on the plurality of BEV sensor measurements. The controller is further programmed to repeat the record the plurality of sensor measurements, generate the plurality of BEV sensor measurements, and update the CTM of each of the two or more sensors steps until a CTM convergence threshold is reached for the CTM of each of the two or more sensors.

In another aspect of the present disclosure, one or more of the two or more sensors is at least one of: a camera and a light detection and ranging (LIDAR) sensor configured to image an environment surrounding the vehicle.

In another aspect of the present disclosure, to generate the plurality of BEV sensor measurements, the controller is further programmed to generate the plurality of BEV sensor measurements by transforming each of the plurality of sensor measurements into the BEV coordinate space using the CTM of each of the two or more sensors. The CTM of each of the two or more sensors describes extrinsic parameters of each of the two or more sensors.

In another aspect of the present disclosure, to generate the plurality of BEV sensor measurements, the controller is further programmed to generate the plurality of BEV sensor measurements by transforming each of the plurality of sensor measurements into the BEV coordinate space using the CTM of each of the two or more sensors. Each of the plurality of BEV sensor measurements is a BEV representation of one of the plurality of sensor measurements from one of the two or more sensors.

In another aspect of the present disclosure, the machine learning model is configured to receive the plurality of BEV sensor measurements as a multi-channel input and provide an adjustment matrix for the CTM of each of the two or more sensors as an output.

In another aspect of the present disclosure, to update the CTM of each of the two or more sensors, the controller is further programmed to provide the plurality of BEV sensor measurements to the machine learning model. The multi-channel input which includes information about a spatial relationship between each of the plurality of BEV sensor measurements. To update the CTM of each of the two or more sensors, the controller is further programmed to generate the adjustment matrix for the CTM of each of the two or more sensors using a vision-based neural network of the machine learning model based at least in part on the multi-channel input. To update the CTM of each of the two or more sensors, the controller is further programmed to update the CTM of each of the two or more sensors using the adjustment matrix for the CTM of each of the two or more sensors.

In another aspect of the present disclosure, the CTM convergence threshold is reached when a magnitude of each of one or more values of the adjustment matrix is less than or equal to the CTM convergence threshold.

According to several aspects, a method for calibrating a coordinate transformation matrix (CTM) for two or more cameras for a vehicle is provided. The method may include recording a plurality of images using two or more cameras. The method further may include generating a plurality of bird's-eye-view (BEV) images by transforming each of the plurality of images into a BEV coordinate space using the CTM of each of the two or more cameras. The BEV coordinate space is a two-dimensional coordinate space relative to the two or more cameras. Each of the plurality of BEV images is a BEV representation of one of the plurality of images from one of the two or more cameras. The method further may include updating the CTM of each of the two or more cameras using a machine learning model based at least in part on the plurality of BEV images. The method further may include repeating the recording the plurality of images, generating the plurality of BEV images, and updating the CTM of each of the two or more cameras steps until a CTM convergence threshold is reached for the CTM of each of the two or more cameras.

In another aspect of the present disclosure, the method further includes training the machine learning model. Training the machine learning model further may include recording a plurality of training images using the two or more cameras. Training the machine learning model further may include generating a plurality of training BEV images by transforming the each of the plurality of training images into the BEV coordinate space using a ground-truth CTM of each of the two or more cameras injected with a randomized error. Training the machine learning model further may include training the machine learning model based at least in part on the plurality of training BEV images and the ground-truth CTM for each of the two or more cameras.

In another aspect of the present disclosure, updating the CTM of each of the two or more cameras further may include providing the plurality of BEV images to the machine learning model. The plurality of BEV images are provided to the machine learning model as a multi-channel input which includes information about a spatial relationship between each of the plurality of BEV images. Updating the CTM of each of the two or more cameras further may include generating an adjustment matrix for the CTM of each of the two or more cameras using a vision-based neural network of the machine learning model based at least in part on the multi-channel input, where a magnitude of each of one or more values of the adjustment matrix is less than or equal to a predetermined maximum adjustment threshold. Updating the CTM of each of the two or more cameras further may include updating the CTM of each of the two or more cameras using the adjustment matrix for the CTM of each of the two or more cameras.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for calibrating a coordinate transformation matrix (CTM) for two or more sensors, according to an exemplary embodiment;

FIG. 2 is a flowchart of a method for calibrating a coordinate transformation matrix (CTM) for two or more sensors, according to an exemplary embodiment; and

FIG. 3 is a flowchart of a method for training a machine learning model for calibrating a coordinate transformation matrix (CTM) for two or more sensors, according to an exemplary embodiment.

### DETAILED DESCRIPTION

The following description is merely exemplary in nature and is not intended to limit the present disclosure, application, or uses.

In aspects of the present disclosure, data received from multiple sensors may be stitched, aligned, and/or fused to create a more complete perception of the environment, such as, for example, a “bird’s-eye-view” of the environment. To accurately stitch, align, and/or fuse data from multiple sensors, the data can be transformed into a common coordinate system relative to the environment using a coordinate transformation matrix (CTM) for each of the multiple sensors. A CTM encodes information about extrinsic parameters (pitch, yaw, roll, and position) of a sensor. Due to variations in sensor manufacturing and installation, it is advantageous to calibrate the CTM for each of the multiple sensors after installation and service. Furthermore, it is advantageous to periodically re-calibrate the CTM for each of the multiple sensors to mitigate accuracy degradation due to sensor movement using use. The present disclosure provides a new and improved system and method for calibrating CTMs for sensors which does not require the use of specialized equipment such as calibration targets.

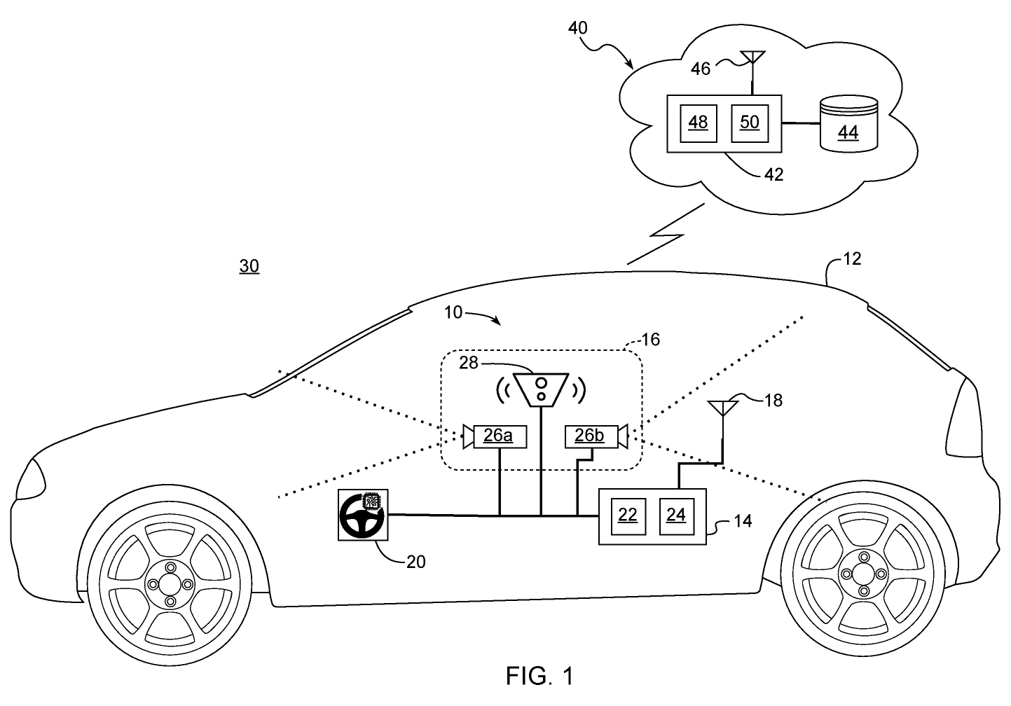

Referring to FIG. 1, a system for calibrating a coordinate transformation matrix (CTM) for two or more sensors of a vehicle is illustrated and generally indicated by reference number 10. The system 10 is shown with an exemplary vehicle 12. While a passenger vehicle is illustrated, it should be appreciated that the vehicle 12 may be any type of vehicle without departing from the scope of the present disclosure. The system 10 generally includes a controller 14, two or more sensors 16, a vehicle communication system 18 and an automated driving system 20.

The controller 14 is used to implement a method 100 for calibrating a coordinate transformation matrix (CTM) for two or more sensors of a vehicle, as will be described below. The controller 14 includes at least one processor 22 and a non-transitory computer readable storage device or media 24. The processor 22 may be a custom made or commercially available processor, a central processing unit (CPU), a graphics processing unit (GPU), an auxiliary processor among several processors associated with the controller 14, a semiconductor-based microprocessor (in the form of a microchip or chip set), a macroprocessor, a combination thereof, or generally a device for executing instructions.

The computer readable storage device or media 24 may include volatile and nonvolatile storage in read-only memory (ROM), random-access memory (RAM), and keep-alive memory (KAM), for example. KAM is a persistent or non-volatile memory that may be used to store various operating variables while the processor 22 is powered down. The computer-readable storage device or media 24 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 14 to control various systems of the vehicle 12.

The controller 14 may also include multiple controllers which are in electrical communication with each other. The controller 14 may be inter-connected with additional systems and/or controllers of the vehicle 12, allowing the controller 14 to access data such as, for example, speed, acceleration, braking, and steering angle of the vehicle 12.

The controller 14 is in electrical communication with the two or more sensors 16, the vehicle communication system 18, and the automated driving system 20. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the controller 14 are within the scope of the present disclosure. It should further be understood that, in the scope of the present disclosure, electrical communication also includes power and/or energy transfer between electrical devices (e.g., using conducting wires and/or wireless power transmission techniques).

The two or more sensors 16 are used to acquire information relevant to the vehicle 12. In an exemplary embodiment, at least one of the two or more sensors 16 includes a camera 26a, 26b. In another exemplary embodiment, at least one of the two or more sensors 16 is a light detection and ranging (LIDAR) sensor 28. In an exemplary embodiment, the two or more sensors 16 includes two or more cameras 26a, 26b. It should be understood that the two or more sensors 16 may include additional and/or alternate sensors without departing from the scope of the present disclosure.

In another exemplary embodiment, the two or more sensors 16 further include sensors to determine performance data about the vehicle 12. In a non-limiting example, the two or more sensors 16 further include at least one of a motor speed sensor, a motor torque sensor, an electric drive motor voltage and/or current sensor, an accelerator pedal position sensor, a brake position sensor, a coolant temperature sensor, a cooling fan speed sensor, and a transmission oil temperature sensor.

In another exemplary embodiment, the two or more sensors 16 further include sensors to determine information about an environment within the vehicle 12. In a non-limiting example, the two or more sensors 16 further include at least one of a seat occupancy sensor, a cabin air temperature sensor, a cabin motion detection sensor, a cabin camera, a cabin microphone, and/or the like.

In another exemplary embodiment, the two or more sensors 16 further include sensors to determine information about an environment 30 surrounding the vehicle 12. In a non-limiting example, the two or more sensors 16 further include at least one of an ambient air temperature sensor, a barometric pressure sensor, a global navigation satellite system (GNSS), and/or a photo and/or video camera which is positioned to view the environment 30 in front of the vehicle 12.

In another exemplary embodiment, at least one of the two or more sensors 16 is a perception sensor capable of perceiving objects and/or measuring distances in the environment 30 surrounding the vehicle 12. In a non-limiting example, the two or more sensors 16 includes a stereoscopic camera having distance measurement capabilities. In one example, at least one of the two or more sensors 16 is affixed inside of the vehicle 12, for example, in a headliner of the vehicle 12, having a view through a windscreen of the vehicle 12. In another example, at least one of the two or more sensors 16 is affixed outside of the vehicle 12, for example, on a roof of the vehicle 12, having a view of the environment 30 surrounding the vehicle 12. It should be understood that various additional types of perception sensors, such as, for example, ultrasonic ranging sensors, radar sensors, and/or time-of-flight sensors are within the scope of the present disclosure. The two or more sensors 16 are in electrical communication with the controller 14 as discussed above.

The camera 26a, 26b is a perception sensor used to capture images and/or videos of the environment 30 surrounding the vehicle 12. In an exemplary embodiment, the camera 26a, 26b includes a photo and/or video camera which is positioned to view the environment 30 surrounding the vehicle 12. In a non-limiting example, the camera 26a, 26b includes a camera affixed inside of the vehicle 12, for example, in a headliner of the vehicle 12, having a view through the windscreen. In another non-limiting example, the camera 26a, 26b includes a camera affixed outside of the vehicle 12, for example, on a roof of the vehicle 12, having a view of the environment 30 in front of the vehicle 12.

In another exemplary embodiment, the camera 26a, 26b refers to a surround view camera system including a plurality of cameras arranged to provide a view of the environment 30 adjacent to two or more sides of the vehicle 12. In a non-limiting example, the camera 26a, 26b includes a front-facing camera (mounted, for example, in a front grille of the vehicle 12), a rear-facing camera (mounted, for example, on a rear tailgate of the vehicle 12), and two side-facing cameras (mounted, for example, under each of two side-view mirrors of the vehicle 12). In another non-limiting example, the camera 26a, 26b further includes an additional rear-view camera mounted near a center high mounted stop lamp of the vehicle 12. Accordingly, the camera 26a, 26b is configured to capture images showing an environment in front of the vehicle 12, images showing an environment behind the vehicle 12, images showing an environment left of the vehicle 12, and images showing an environment right of the vehicle 12. In a non-limiting example, the two side-facing cameras include both front and rear facing side cameras, allowing the camera 26a, 26b to capture a front- and rear-ward view on each side of the vehicle 12.

In some embodiments, the images captured by the surround view camera system may be aligned and stitched together to provide a “bird’s-eye-view” (BEV) of the environment 30 surrounding the vehicle 12. In a non-limiting example, the BEV is a top-down representation of the environment 30 surrounding the vehicle 12. For example, the BEV can be used to provide a graphical representation of the environment 30 surrounding the vehicle 12 to an occupant of the vehicle 12. In another example, the BEV can be used by the automated driving system 20 to detect objects in the environment 30, determine locations of objects relative to the vehicle 12, and control the vehicle 12 accordingly.

It should be understood that camera systems having additional cameras and/or additional mounting locations are within the scope of the present disclosure. It should be understood that the system 10 and method 100 of the present disclosure may also be used with fewer cameras, but more cameras will provide a more complete view of the environment 30. It should further be understood that cameras having various sensor types including, for example, charge-coupled device (CCD) sensors, complementary metal oxide semiconductor (CMOS) sensors, and/or high dynamic range (HDR) sensors are within the scope of the present disclosure. Furthermore, cameras having various lens types including, for example, wide-angle lenses and/or narrow-angle lenses are also within the scope of the present disclosure.

The vehicle communication system 18 is used by the controller 14 to communicate with other systems external to the vehicle 12. For example, the vehicle communication system 18 includes capabilities for communication with vehicles (“V2V” communication), infrastructure (“V2I” communication), remote systems at a remote call center (e.g., ON-STAR by GENERAL MOTORS) and/or personal devices. In general, the term vehicle-to-everything communication (“V2X” communication) refers to communication between the vehicle 12 and any remote system (e.g., vehicles, infrastructure, and/or remote systems).

In certain embodiments, the vehicle communication system 18 is a wireless communication system configured to communicate via a wireless local area network (WLAN) using IEEE 802.11 standards or by using cellular data communication (e.g., using GSMA standards, such as, for example, SGP.02, SGP.24, SGP.32, and the like). Accordingly, the vehicle communication system 18 may further include an embedded universal integrated circuit card (eUICC) configured to store at least one cellular connectivity configuration profile, for example, an embedded subscriber identity module (eSIM) profile.

The vehicle communication system 18 is further configured to communicate via a personal area network (e.g., BLUETOOTH), near-field communication (NFC), and/or any additional type of radiofrequency communication. However, additional or alternate communication methods, such as a dedicated short-range communications (DSRC) channel and/or mobile telecommunications protocols based on the 3rd Generation Partnership Project (3GPP) standards, are also considered within the scope of the present disclosure. DSRC channels refer to one-way or two-way short-range to medium-range wireless communication channels specifically designed for automotive use and a corresponding set of protocols and standards. The 3GPP refers to a partnership between several standards organizations which develop protocols and standards for mobile telecommunications. 3GPP standards are structured as “releases”. Thus, communication methods based on 3GPP release 14, 15, 16 and/or future 3GPP releases are considered within the scope of the present disclosure.

Accordingly, the vehicle communication system 18 may include one or more antennas and/or communication transceivers for receiving and/or transmitting signals, such as cooperative sensing messages (CSMs). The vehicle communication system 18 is configured to wirelessly communicate information between the vehicle 12 and another vehicle. Further, the vehicle communication system 18 is configured to wirelessly communicate information between the vehicle 12 and infrastructure or other vehicles. It should be understood that the vehicle communication system 18 may be integrated with the controller 14 (e.g., on a same circuit board with the controller 14 or otherwise a part of the controller 14) without departing from the scope of the present disclosure.

The automated driving system 20 is used to provide assistance to the occupant to increase occupant awareness and/or control behavior of the vehicle 12. In the scope of the present disclosure, the automated driving system 20 encompasses systems which provide any level of assistance to the occupant (e.g., blind spot warning, lane departure warning, and/or the like) and systems which are capable of autonomously driving the vehicle 12 under some or all conditions (e.g., automated lane keeping, adaptive cruise control, fully autonomous driving, and/or the like). It should be understood that all levels of driving automation defined by, for example, SAE J3016 (i.e., SAE LEVEL 0, SAE LEVEL 1, SAE LEVEL 2, SAE LEVEL 3, SAE LEVEL 4, and SAE LEVEL 5) are within the scope of the present disclosure.

In an exemplary embodiment, the automated driving system 20 is configured to detect and/or receive information about the environment 30 surrounding the vehicle 12 and process the information to provide assistance to the occupant. In some embodiments, the automated driving system 20 includes a software module executed on the controller 14. In other embodiments, the automated driving system 20 includes a separate automated driving system controller, similar to the controller 14, capable of processing the information about the environment 30 surrounding the vehicle 12. In an exemplary embodiment, the automated driving system 20 may operate in a manual operation mode, a partially automated operation mode, and a fully automated operation mode.

In the scope of the present disclosure, the manual operation mode means that the automated driving system 20 provides warnings or notifications to the occupant but does not intervene or control the vehicle 12 directly. In a non-limiting example, the automated driving system 20 receives information from the two or more sensors 16 (e.g., the BEV). Using techniques such as, for example, computer vision, the automated driving system 20 understands the environment 30 surrounding the vehicle 12 and provides assistance to the occupant. For example, if the automated driving system 20 identifies, based on data from the two or more sensors 16, that the vehicle 12 is likely to collide with a remote vehicle, the automated driving system 20 may use a display to provide a warning to the occupant.

In the scope of the present disclosure, the partially automated operation mode means that the automated driving system 20 provides warnings or notifications to the occupant and may intervene or control the vehicle 12 directly in certain situations. In a non-limiting example, the automated driving system 20 is additionally in electrical communication with components of the vehicle 12 such as a brake system, a propulsion system, and/or a steering system of the vehicle 12, such that the automated driving system 20 may control the behavior of the vehicle 12. In a non-limiting example, the automated driving system 20 may control the behavior of the vehicle 12 by applying brakes of the vehicle 12 to avoid an imminent collision. In another non-limiting example, the automated driving system 20 may control the steering system of the vehicle 12 to provide an automated lane keeping feature. In another non-limiting example, the automated driving system 20 may control the brake system, propulsion system, and steering system of the vehicle 12 to temporarily drive the vehicle 12 towards a predetermined destination. However, intervention by the occupant may be required at any time. In an exemplary embodiment, the automated driving system 20 may include additional components such as, for example, an eye tracking device configured to monitor an attention level of the occupant and ensure that the occupant is prepared to take over control of the vehicle 12.

In the scope of the present disclosure, the fully automated operation mode means that the automated driving system 20 uses data from the two or more sensors 16 (e.g., the BEV) to understand the environment 30 and control the vehicle 12 to drive the vehicle 12 to a predetermined destination without a need for control or intervention by the occupant.

The automated driving system 20 operates using a path planning algorithm which is configured to generate a safe and efficient trajectory for the vehicle 12 to navigate in the environment surrounding the vehicle 12. In an exemplary embodiment, the path planning algorithm is a machine learning algorithm trained to output control signals for the vehicle 12 based on input data collected from the two or more sensors 16 (e.g., the BEV). In another exemplary embodiment, the path planning algorithm is a deterministic algorithm which has been programmed to output control signals for the vehicle 12 based on data collected from the two or more sensors 16 (e.g., the BEV).

In a non-limiting example, the path planning algorithm generates a sequence of waypoints or a continuous path that the vehicle 12 should follow to reach a destination while adhering to rules, regulations, and safety constraints. The sequence of waypoints or continuous path is generated based at least in part on a detailed map and a current state of the vehicle 12 (i.e., position, velocity, and orientation of the vehicle 12). The detailed map includes, for example, information about lane boundaries, road geometry, speed limits, traffic signs, and/or other relevant features. In an exemplary embodiment, the detailed map is stored in the media 24 of the controller 14 and/or on a remote database or server. In another exemplary embodiment, the path planning algorithm performs perception and mapping tasks to interpret data collected from the two or more sensors 16 (e.g., the BEV) and create, update, and/or augment the detailed map.

It should be understood that the automated driving system 20 may include any software and/or hardware module configured to operate in the manual operation mode, the partially automated operation mode, or the fully automated operation mode as described above.

With continued reference to FIG. 1, a remote server system is illustrated and generally indicated by reference number 40. The remote server system 40 includes a server controller 42 in electrical communication with a server database 44 and a server communication system 46. In a non-limiting example, the remote server system 40 is located in a server farm, datacenter, or the like, and connected to the internet.

The server controller 42 includes at least one server processor 48 and a server non-transitory computer readable storage device or server media 50. The description of the type and configuration given above for the controller 14 also applies to the server controller 42. In some examples, the server controller 42 may differ from the controller 14 in that the server controller 42 is capable of a higher processing speed, includes more memory, includes more inputs/outputs, and/or the like. In a non-limiting example, the server controller 42 includes one or more graphics processing units (GPU) or other purpose-built processing units configured for training and/or execution of machine learning models. In a non-limiting example, the server processor 48 and server media 50 of the server controller 42 are similar in structure and/or function to the processor 22 and the media 24 of the controller 14, as described above.

The server database 44 is used to store images and bird’s-eye-view representations of environments surrounding vehicles and machine learning training data, as will be discussed in greater detail below. In an exemplary embodiment, the server database 44 includes one or more mass storage devices, such as, for example, hard disk drives, magnetic tape drives, magneto-optical disk drives, optical disks, solid-state drives, and/or additional devices operable to store data in a persisting and machine-readable fashion. In some examples, the one or more mass storage devices may be configured to provide redundancy in case of hardware failure and/or data corruption, using, for example, a redundant array of independent disks (RAID). In a non-limiting example, the server controller 42 may execute software such as, for example, a database management system (DBMS), allowing data stored on the one or more mass storage devices to be organized and accessed.

The server communication system 46 is used to communicate with external systems, such as, for example, the controller 14 via the vehicle communication system 18. In a non-limiting example, the server communication system 46 is similar in structure and/or function to the vehicle communication system 18, as described above. In some examples, the server communication system 46 may differ from the vehicle communication system 18 in that the server communication system 46 is capable of higher power signal transmission, more sensitive signal reception, higher bandwidth transmission, additional transmission/reception protocols, and/or the like.

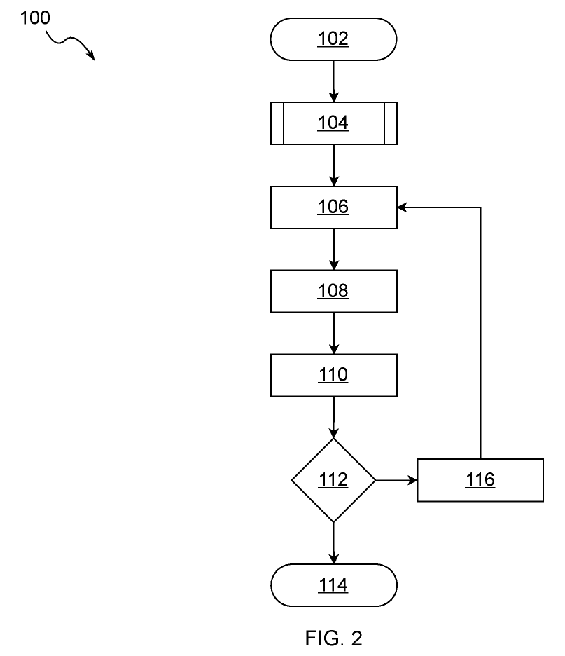

Referring to FIG. 2, a flowchart of the method 100 for calibrating a coordinate transformation matrix (CTM) for two or more sensors of a vehicle begins at block 102 and proceeds to block 104. In an exemplary embodiment, a CTM is a matrix which describes a mathematical transformation between coordinates in data captured by one of the two or more sensors 16 and coordinates in the bird’s-eye-view (BEV) of the real-world environment 30 surrounding the vehicle 12 (also referred to as a BEV coordinate space). In another exemplary embodiment, a CTM is a matrix which describes a mathematical transformation between coordinates in data captured by one of the two or more sensors 16 and coordinates of a point on the vehicle 12. In another exemplary embodiment, a CTM is a matrix which describes a mathematical transformation between coordinates in data captured by one of the two or more sensors 16 and coordinates of another of the two or more sensors 16. Each of the two or more sensors 16 has a CTM which is based on extrinsic parameters (e.g., pitch, yaw, roll, x, y, z location) of each of the two or more sensors 16. At block 104, a machine learning model is trained to align sensor data. In an exemplary embodiment, the machine learning model is trained to receive a multi-channel input including data from the two or more sensors 16 and provide an adjustment matrix for the CTM of each of the two or more sensors 16 as output. The process for training the machine learning model will be discussed in greater detail below. After block 104, the method 100 proceeds to block 106.

At block 106, the controller 14 uses the two or more sensors 16 to record a plurality of sensor measurements. In an exemplary embodiment, the plurality of sensor measurements include a plurality of images captured using the cameras 26a, 26b. In a non-limiting example, the plurality of images include an image showing an environment in front of the vehicle 12, an image showing an environment right of the vehicle 12, an image showing an environment behind the vehicle 12, and an image showing an environment left of the vehicle 12. In another exemplary embodiment, the plurality of sensor measurements include a plurality of LIDAR data. In a non-limiting example, the plurality of LIDAR data includes LIDAR measurements of the environment in front of the vehicle 12, LIDAR measurements of the environment right of the vehicle 12, LIDAR measurements of the environment behind the vehicle 12, and LIDAR measurements of the environment left of the vehicle 12. It should be understood that the plurality of sensor measurements may include additional types of data such as ultrasonic sensor data, time-of-flight sensor data, radar data, and/or the like without departing from the scope of the present disclosure. After block 106, the method 100 proceeds to block 108.

At block 108, the controller 14 generates a plurality of bird’s-eye-view (BEV) sensor measurements. In an exemplary embodiment, the controller 14 generates the plurality of BEV sensor measurements by transforming each of the plurality of sensor measurements recorded at block 106 into the BEV coordinate space. In the scope of the present disclosure, the BEV coordinate space is a two-dimensional coordinate space describing locations in the real-world environment 30 surrounding the vehicle 12 relative to the two or more sensors 16.

In a non-limiting example, to generate each of the plurality of BEV sensor measurements, the coordinates of one of the plurality of sensor measurements are multiplied with the corresponding CTM of the one of the two or more sensors 16 which captured the one of the plurality of sensor measurements. This is repeated for each of the plurality of sensor measurements using the corresponding CTM of each of the two or more sensors 16. Therefore, each of the plurality of BEV sensor measurements is a BEV representation of one of the plurality of sensor measurements from one of the two or more sensors 16.

Furthermore, the plurality of BEV sensor measurements include information about a field of view of each of the two or more sensors 16 because the coordinates in each of the plurality of BEV sensor measurements describe locations in the real-world environment 30 surrounding the vehicle 12 relative to the two or more sensors 16. Therefore, the plurality of BEV sensor measurements also include information about overlap in the field of view of each of the plurality of sensor measurements based on common or overlapping coordinates in each of the plurality of BEV sensor measurements. In an exemplary embodiment where the plurality of sensor measurements include the plurality of images captured using the cameras 26a, 26b, the plurality of BEV sensor measurements are referred to as a plurality of BEV images. After block 108, the method 100 proceeds to block 110.

At block 110, the controller 14 uses the machine learning model trained at block 104 to generate an adjustment matrix for the CTM of each of the two or more sensors 16. In an exemplary embodiment, the controller 14 provides the machine learning model with a multi-channel input including each of the plurality of BEV sensor measurements. As discussed above, the plurality of BEV sensor measurements (and thus the multi-channel input) includes information about a spatial relationship between each of the plurality of BEV sensor measurements (i.e., because the coordinates in each of the plurality of BEV sensor measurements describe locations in the real-world environment 30). In a non-limiting example, each channel of the multi-channel input corresponds to one of the plurality of BEV sensor measurements from one of the two or more sensors 16.

In an exemplary embodiment, the machine learning model uses a vision-based neural network (e.g., a convolutional neural network or the like) to generate the adjustment matrix for the CTM of each of the two or more sensors 16 based at least in part on the multi-channel input. In the scope of the present disclosure, the adjustment matrix for each of the two or more sensors 16 describes an adjustment to the corresponding CTM to improve the accuracy of the CTM. The machine learning model is configured to provide adjustment matrices instead of final CTM matrices to avoid overfitting during training. In an exemplary embodiment, the machine learning model is configured to limit a magnitude of each of one or more values of the adjustment matrix to be less than or equal to a predetermined maximum adjustment threshold. In a non-limiting example, limiting the magnitude of each of one or more values of the adjustment matrix has multiple benefits, such as improving optimization stability and convergence and avoiding local minima traps. Therefore, the method 100 operates as an iterative process and may be executed multiple times to incrementally calibrate the CTM of each of the two or more sensors 16, as will be discussed below. After generating the adjustment matrix for the CTM of each of the two or more sensors 16, the method 100 proceeds to block 112.

At block 112, the controller 14 compares the adjustment matrix for the CTM of each of the two or more sensors 16 generated at block 110 to a CTM convergence threshold. If the magnitude of each of the one or more values of the adjustment matrix for the CTM of each of the two or more sensors 16 is less than or equal to the CTM convergence threshold, the calibration has converged, the CTM of each of the two or more sensors 16 is saved in the media 22, and the method 100 proceeds to enter a standby state at block 114. If the magnitude of at least one of the one or more values of the adjustment matrix for the CTM of at least one of the two or more sensors 16 is greater than the CTM convergence threshold, the method 100 proceeds to block 116. In another exemplary embodiment, the CTM convergence threshold is implemented with a standard deviation (STD) threshold, and the STD of each of the one or more values of the adjustment matrix for the CTM of each of the two or more sensors 16 is compared to the STD threshold at block 112.

At block 116, the controller 14 updates the CTM of each of the two or more sensors 16 based on the adjustment matrix for the CTM of each of the two or more sensors 16 generated at block 110. In an exemplary embodiment, for each CTM, the controller 14 adds the corresponding adjustment matrix to each CTM to produce an updated CTM. The updated CTM for each of the two or more sensors 16 is saved in the media 24 of the controller 14. After block 116, the method 100 returns to block 106 to perform another iteration and incrementally update the CTM for each of the two or more sensors 16 until convergence is reached at block 112.

In an exemplary embodiment, the controller 14 repeatedly exits the standby state 114 and restarts the method 100 at block 102 or block 106. In a non-limiting example, the controller 14 exits the standby state 114 and restarts the method 100 on a timer, for example, every three hundred milliseconds.

In an exemplary embodiment, after reaching convergence at block 112, the controller 14 then uses the updated CTM for each of the two or more sensors 16 to generate accurate bird’s-eye-views of the environment 30. In a non-limiting example, the bird’s-eye-views are displayed to an occupant of the vehicle 12 when driving, for example, to assist with maneuvering and/or parking the vehicle 12. In another non-limiting example, the bird’s-eye-views are processed by the automated driving system 20 to enable the automated driving system 20 to effectively navigate the vehicle 12 through the environment 30. In an exemplary embodiment, the method 100 is periodically re-executed to re-calibrate the CTM for each of the two or more sensors 16. In another exemplary embodiment, the method 100 is re-executed to re-calibrate the CTM for each of the two or more sensors 16 after service or replacement of components of the vehicle 12 such as the two or more sensors 16.

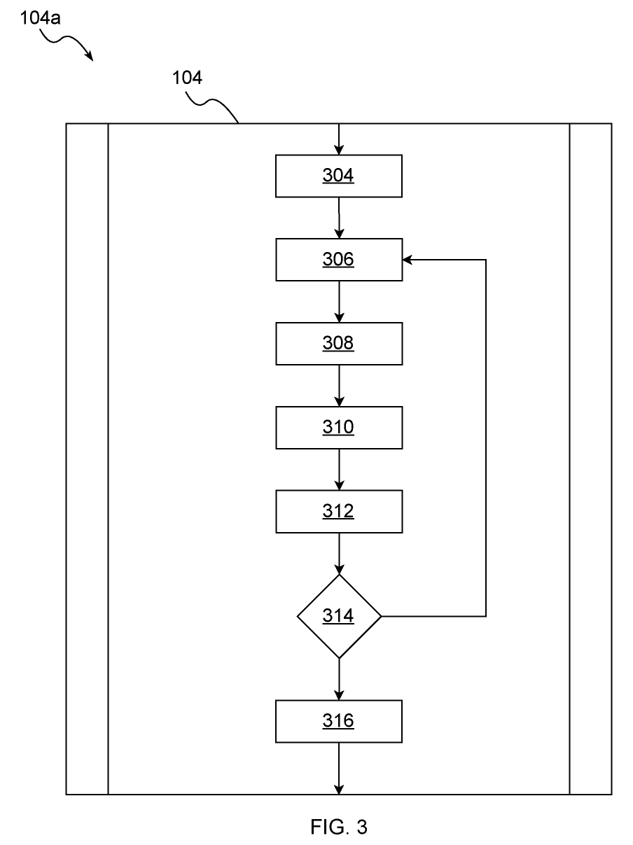

Referring to FIG. 3, a flowchart of a first exemplary embodiment 104a of block 104 of the method 100 is shown. In an exemplary embodiment, the first exemplary embodiment 104a of block 104 is performed using the system 10 and the remote server system 40. It should be understood that the first exemplary embodiment 104a of block 104 may be performed entirely using the system 10 without departing from the scope of the present disclosure. The first exemplary embodiment 104a of block 104 begins at block 304. At block 304, a ground-truth CTM for each of the two or more sensors 16 is determined. In the scope of the present disclosure, the ground-truth CTM is a known correct CTM. In a non-limiting example, the ground-truth CTM for each of the two or more sensors 16 is determined by manual measurement of the extrinsic parameters of each of the two or more sensors 16. In another non-limiting example, the ground-truth CTM for each of the two or more sensors 16 is determined using another CTM calibration method (e.g., a method involving stationary calibration targets placed in the environment 30). After determining the ground-truth CTM, the first exemplary embodiment 104a of block 104 proceeds to block 306.

At block 306, the controller 14 uses the two or more sensors 16 to record a plurality of training sensor measurements. In an exemplary embodiment, the plurality of training sensor measurements include a plurality of training images captured using the cameras 26a, 26b. In a non-limiting example, the plurality of training images include an image showing an environment in front of the vehicle 12, an image showing an environment right of the vehicle 12, an image showing an environment behind the vehicle 12, and an image showing an environment left of the vehicle 12. In another exemplary embodiment, the plurality of training sensor measurements include a plurality of training LIDAR data. In a non-limiting example, the plurality of training LIDAR data includes LIDAR measurements of an environment in front of the vehicle 12, LIDAR measurements of an environment right of the vehicle 12, LIDAR measurements of an environment behind the vehicle 12, and LIDAR measurements of an environment left of the vehicle 12. It should be understood that the plurality of training sensor measurements may include additional types of data such as ultrasonic sensor data, time-of-flight sensor data, radar data, and/or the like without departing from the scope of the present disclosure. After block 306, the ground-truth CTM for each of the two or more sensors 16 and the plurality of training sensor measurements are transmitted to the remote server system 40 using the vehicle communication system 18 and the first exemplary embodiment 104a of block 104 proceeds to block 308.

At block 308, the server controller 42 receives the ground-truth CTM for each of the two or more sensors 16 and the plurality of training sensor measurements using the server communication system 46 and injects the ground-truth CTM for each of the two or more sensors 16 with a randomized error. In an exemplary embodiment, the randomized error is limited within predetermined error magnitude bounds. In an exemplary embodiment, a randomized error is applied to each of the extrinsic parameters in the ground-truth CTM. The error-injected CTM for each of the two or more sensors 16 is referred to as a training CTM. After block 308, the first exemplary embodiment 104aof block 104 proceeds to block 310.

At block 310, the server controller 42 generates a plurality of training bird’s-eye-view (BEV) sensor measurements. In an exemplary embodiment, the server controller 42 generates the plurality of training BEV sensor measurements by transforming each of the plurality of training sensor measurements recorded at block 306 into the BEV coordinate space. In the scope of the present disclosure, the BEV coordinate space is a two-dimensional coordinate space describing locations in the real-world environment 30 surrounding the vehicle 12 relative to the two or more sensors 16.

In a non-limiting example, to generate each of the plurality of training BEV sensor measurements, the coordinates of one of the plurality of training sensor measurements are multiplied with the corresponding training CTM (generated at block 308) of the one of the two or more sensors 16 which captured the one of the plurality of training sensor measurements. This is repeated for each of the plurality of training sensor measurements using the corresponding training CTM of each of the two or more sensors 16. Therefore, each of the plurality of training BEV sensor measurements is a BEV representation of one of the plurality of training sensor measurements from one of the two or more sensors 16 including artificially added error from the training CTM generated at block 308. In an exemplary embodiment where the plurality of training sensor measurements include the plurality of training images captured using the cameras 26a, 26b, the plurality of training BEV sensor measurements are referred to as a plurality of training BEV images. After block 310, the first exemplary embodiment 104a of block 104 proceeds to block 312.

At block 312, the server controller 42 saves a training sample in the server database 44. In an exemplary embodiment, the training sample includes inputs and labels. The inputs represent inputs to the machine learning model and the labels represent the corresponding expected output of the machine learning model based on the inputs. In a non-limiting example, the inputs include the training CTM for each of the two or more sensors 16 and the plurality of training BEV sensor measurements. The labels include a difference between the ground-truth CTM and the training CTM for each of the two or more sensors 16. After block 312, the first exemplary embodiment 104aof block 104 proceeds to block 314.

At block 314, if the server database 44 has less than a predetermined training sample quantity, the first exemplary embodiment 104a of block 104 returns to block 306 to create an additional training sample. If the server database 44 has greater than or equal to the predetermined training sample quantity, the first exemplary embodiment 104a of block 104 proceeds to block 316.

At block 316, the server controller 42 trains the machine learning model using the training samples in the server database 44. In an exemplary embodiment, the server controller 42 uses gradient descent to update model parameters of the vision-based neural network of the machine learning model to minimize a mean-squared-error (MSE) between an output of the machine learning model and the label (i.e., the correct output) for a given training sample. After multiple iterations (also referred to as epochs), when the decrease in the MSE reaches a plateau, the machine learning model is trained.

It should be understood that the process for training the machine learning model described above is merely exemplary in nature, and that various additional and/or alternative methods for training the machine learning model based on the training samples are within the scope of the present disclosure. It should also be understood that the machine learning model may be trained using data from multiple vehicles (e.g., via crowdsourcing), different types (i.e., models) of vehicles, and/or the like. Furthermore, the trained machine learning model may be applicable for use with other vehicles besides the vehicle 12, for example, vehicles having a similar sensor configuration to the vehicle 12. After block 316, the trained machine learning model is transferred to the vehicle 12 (e.g., using the server communication system 46) and saved in the media 24 of the controller 14 for use by the controller 14 as discussed above, the first exemplary embodiment 104a of block 104 is concluded, and the method 100 proceeds as discussed above.

The system 10 and method 100 of the present disclosure offer several advantages. For example, the system 10 and method 100 do not require specialized equipment such as calibration targets. Furthermore, the system 10 and method 100 are effective both when the vehicle 12 is stationary and when the vehicle 12 is in motion, even at high speeds. Additionally, the system 10 and method 100 can provide a faster convergence time and higher accuracy than other methods. Therefore, the system 10 and method 100 can be performed often, resulting in increased CTM accuracy during operation of the vehicle 12. The system 10 and method 100 are also sensor agnostic, meaning that they are effective to calibrate CTMs of various types of sensors and combinations of different sensor types (e.g., cameras, LIDAR, etc.). Improved speed, accuracy, and frequency of CTM calibration results in improvements in information displayed to the occupant based on sensor data and improvements in automated driving tasks which rely on accurate sensor data.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for calibrating a coordinate transformation matrix (CTM) for two or more sensors, the method comprising:
training a machine learning model to align sensor data;
recording a plurality of sensor measurements using two or more sensors;
generating a plurality of bird's-eye-view (BEV) sensor measurements by transforming each of the plurality of sensor measurements into a BEV coordinate space using the CTM of each of the two or more sensors, wherein the BEV coordinate space is a two-dimensional coordinate space relative to the two or more sensors;
updating the CTM of each of the two or more sensors using the machine learning model based at least in part on the plurality of BEV sensor measurements; and
repeating the recording the plurality of sensor measurements, generating the plurality of BEV sensor measurements, and updating the CTM of each of the two or more sensors steps until a CTM convergence threshold is reached for the CTM of each of the two or more sensors.

2. The method of claim 1, wherein training the machine learning model further comprises:
recording a plurality of training sensor measurements using the two or more sensors;
generating a plurality of training BEV sensor measurements based at least in part on the plurality of training sensor measurements; and
training the machine learning model based at least in part on the plurality of training BEV sensor measurements and a ground-truth CTM for each of the two or more sensors.

3. The method of claim 2, wherein generating the plurality of training BEV sensor measurements further comprises:
generating the plurality of training BEV sensor measurements by transforming the each of the plurality of training sensor measurements into the BEV coordinate space using the ground-truth CTM of each of the two or more sensors injected with a randomized error.

4. The method of claim 1, wherein recording the plurality of sensor measurements further comprises:
recording the plurality of sensor measurements using the two or more sensors, wherein one or more of the two or more sensors is a camera.

5. The method of claim 4, wherein recording the plurality of sensor measurements further comprises:
recording the plurality of sensor measurements using the two or more sensors, wherein one or more of the two or more sensors is a light detection and ranging (LIDAR) sensor.

6. The method of claim 1, wherein generating the plurality of BEV sensor measurements further comprises:
generating the plurality of BEV sensor measurements by transforming each of the plurality of sensor measurements into the BEV coordinate space, wherein each of the plurality of BEV sensor measurements is a BEV representation of one of the plurality of sensor measurements from one of the two or more sensors.

7. The method of claim 6, wherein generating the plurality of BEV sensor measurements further comprises:
generating the plurality of BEV sensor measurements, wherein the plurality of BEV sensor measurements include information about a field of view of each of the plurality of sensor measurements, and wherein the plurality of BEV sensor measurements include information about overlap in the field of view of each of the plurality of sensor measurements.

8. The method of claim 1, wherein updating the CTM of each of the two or more sensors further comprises:
providing the plurality of BEV sensor measurements to the machine learning model, wherein the plurality of BEV sensor measurements are provided to the machine learning model as a multi-channel input which includes information about a spatial relationship between each of the plurality of BEV sensor measurements;
generating an adjustment matrix for the CTM of each of the two or more sensors using a vision-based neural network of the machine learning model based at least in part on the multi-channel input; and
updating the CTM of each of the two or more sensors using the adjustment matrix for the CTM of each of the two or more sensors.

9. The method of claim 8, wherein generating the adjustment matrix for the CTM of each of the two or more sensors further comprises:
generating the adjustment matrix for the CTM of each of the two or more sensors, wherein a magnitude of each of one or more values of the adjustment matrix is less than or equal to a predetermined maximum adjustment threshold.

10. The method of claim 8, wherein repeating the recording the plurality of sensor measurements, generating the plurality of BEV sensor measurements, and updating the CTM of each of the two or more sensors steps further comprises:
repeating the recording the plurality of sensor measurements, generating the plurality of BEV sensor measurements, and updating the CTM of each of the two or more sensors steps, wherein the CTM convergence threshold is reached when a magnitude of each of one or more values of the adjustment matrix is less than or equal to the CTM convergence threshold.

11. A system for calibrating a coordinate transformation matrix (CTM) for a vehicle, the system comprising:
two or more sensors;
a controller in electrical communication with the two or more sensors, wherein the controller is programmed to:
record a plurality of sensor measurements using two or more sensors;
generate a plurality of bird's-eye-view (BEV) sensor measurements by transforming each of the plurality of sensor measurements into a BEV coordinate space using the CTM of each of the two or more sensors, wherein the BEV coordinate space is a two-dimensional coordinate space relative to the two or more sensors;
update the CTM of each of the two or more sensors using a machine learning model based at least in part on the plurality of BEV sensor measurements; and
repeat the record the plurality of sensor measurements, generate the plurality of BEV sensor measurements, and update the CTM of each of the two or more sensors steps until a CTM convergence threshold is reached for the CTM of each of the two or more sensors.

12. The system of claim 11, wherein one or more of the two or more sensors is at least one of: a camera and a light detection and ranging (LIDAR) sensor configured to image an environment surrounding the vehicle.

13. The system of claim 11, wherein to generate the plurality of BEV sensor measurements, the controller is further programmed to:
generate the plurality of BEV sensor measurements by transforming each of the plurality of sensor measurements into the BEV coordinate space using the CTM of each of the two or more sensors, wherein the CTM of each of the two or more sensors describes extrinsic parameters of each of the two or more sensors.

14. The system of claim 13, wherein to generate the plurality of BEV sensor measurements, the controller is further programmed to:
generate the plurality of BEV sensor measurements by transforming each of the plurality of sensor measurements into the BEV coordinate space using the CTM of each of the two or more sensors, wherein each of the plurality of BEV sensor measurements is a BEV representation of one of the plurality of sensor measurements from one of the two or more sensors.

15. The system of claim 11, wherein the machine learning model is configured to receive the plurality of BEV sensor measurements as a multi-channel input and provide an adjustment matrix for the CTM of each of the two or more sensors as an output.

16. The system of claim 15, wherein to update the CTM of each of the two or more sensors, the controller is further programmed to:
provide the plurality of BEV sensor measurements to the machine learning model, wherein the multi-channel input which includes information about a spatial relationship between each of the plurality of BEV sensor measurements;
generate the adjustment matrix for the CTM of each of the two or more sensors using a vision-based neural network of the machine learning model based at least in part on the multi-channel input; and
update the CTM of each of the two or more sensors using the adjustment matrix for the CTM of each of the two or more sensors.

17. The system of claim 16, wherein the CTM convergence threshold is reached when a magnitude of each of one or more values of the adjustment matrix is less than or equal to the CTM convergence threshold.

18. A method for calibrating a coordinate transformation matrix (CTM) for two or more cameras for a vehicle, the method comprising:
recording a plurality of images using two or more cameras;
generating a plurality of bird's-eye-view (BEV) images by transforming each of the plurality of images into a BEV coordinate space using the CTM of each of the two or more cameras, wherein the BEV coordinate space is a two-dimensional coordinate space relative to the two or more cameras, and wherein each of the plurality of BEV images is a BEV representation of one of the plurality of images from one of the two or more cameras;
updating the CTM of each of the two or more cameras using a machine learning model based at least in part on the plurality of BEV images; and
repeating the recording the plurality of images, generating the plurality of BEV images, and updating the CTM of each of the two or more cameras steps until a CTM convergence threshold is reached for the CTM of each of the two or more cameras.

19. The method of claim 18, further comprising training the machine learning model, wherein training the machine learning model further comprises:
recording a plurality of training images using the two or more cameras;
generating a plurality of training BEV images by transforming the each of the plurality of training images into the BEV coordinate space using a ground-truth CTM of each of the two or more cameras injected with a randomized error; and
training the machine learning model based at least in part on the plurality of training BEV images and the ground-truth CTM for each of the two or more cameras.

20. The method of claim 19, wherein updating the CTM of each of the two or more cameras further comprises:
providing the plurality of BEV images to the machine learning model, wherein the plurality of BEV images are provided to the machine learning model as a multi-channel input which includes information about a spatial relationship between each of the plurality of BEV images;
generating an adjustment matrix for the CTM of each of the two or more cameras using a vision-based neural network of the machine learning model based at least in part on the multi-channel input, wherein a magnitude of each of one or more values of the adjustment matrix is less than or equal to a predetermined maximum adjustment threshold; and
updating the CTM of each of the two or more cameras using the adjustment matrix for the CTM of each of the two or more cameras.
